(19) United States
(12) Patent Application Publication
(10) Pub. No.: US 2026/0160011 A1
(43) Pub. Date: Jun. 11, 2026

(54) DOSING APPARATUS

(71) Applicant: Herbert Saier GmbH, Gundelfingen (DE)

(72) Inventor: Michael SAIER, Freiburg/Kappel (DE)

(21) Appl. No.: 19/181,049

(22) Filed: Apr. 16, 2025

(30) Foreign Application Priority Data
Apr. 18, 2024 (DE) 10 2024 110 910.6
Jul. 17, 2024 (DE) 10 2024 120 224.6
Oct. 30, 2024 (DE) 10 2024 131 759.0

(51) Int. Cl. D06F 39/02; B08B 9/032; D06F 31/00; G05D 7/06

(52) U.S. Cl. CPC D06F 39/022; B08B 9/0321; D06F 31/00; G05D 7/0688

(57) ABSTRACT

A metering device for metering and supplying media via fluid lines to at least one target apparatus, in particular to a commercial textile washing machine, wherein the metering device has a switching device which is connected on the input side to a metering pump and to a flush pump or to a flushing device and which is connected on the output side to a target apparatus and which can be addressed by a control device of the metering device to change its switch state. The switching device provides a communicative connection between the metering pump and the target apparatus in a first switch state, and, in a second switch state, provides a communicative connection between the flush pump or the flushing device and the target apparatus.

The invention relates firstly to a metering device according to claim 1.

Such metering devices are known from the prior art and widely used.

By way of example only, reference is made to a metering device that is described in EP 2 783 142A1 , which goes back to the applicant.

The known metering device is used for metering and delivering media. It comprises a pump, in particular a peristaltic pump with which it is made possible to take out a predetermined volume of medium from a container and to deliver said medium to a target apparatus in order to perform a metering process.

In certain application cases, the fluid line portions between the container in which the medium is located and the target apparatus have a large length. These line lengths can be 5 m or 10 m, for example, or be designed even longer.

In certain application cases, target apparatuses are to be supplied with medium, wherein the target apparatuses are located at different locations, e.g. in different rooms, or possibly also on different floors of a building.

These long line lengths come with a number of problems: firstly, the capacities of the pumps are often insufficient for pumping the medium along the long line portions of the fluid lines. On the other hand, the pumps can be dimensioned and designed to allow for high delivery pressures or high capacities. However, such scaling can result in a loss of precision for small quantities of media to be metered.

Long fluid line paths also cause fundamental problems in that the delivery times are correspondingly long. This in turn complicates the situation if multiple different target apparatuses are to be fed with medium from one metering device.

Based on this, the object of the invention is to provide a metering device that can be used even with long line lengths between the container and the target apparatus and/or where there are large height differences to be overcome along the fluid lines to ensure safe, reliable and fast delivery of media.

The invention achieves this object with the features of claim 1.

According to a first alternative, the principle of the invention essentially is to equip the metering device with two different pumps, namely a metering pump and a flush pump. These two pumps can be addressed directly or indirectly by the control device of the metering device.

Both pumps can be designed differently. They can e.g. be designed to provide different capacities.

In particular, they serve different purposes: The metering pump can be used conventionally, for example be designed and configured as a peristaltic pump and serves to deliver small but precisely measured quantities of medium from the container in which the medium is located along a first, e.g. only short fluid line portion or one with no major height difference as far as to downstream of a switching device.

The second pump, the so-called flush pump, is used to deliver the medium along a second fluid line portion, in particular along a longer line path or along a line path with a large height difference, to the target apparatus.

While the first pump is designed as a metering pump and can ensure precise quantity measurement, the flush pump can be designed to be optimized for the requirement of higher capacities, e.g. delivering along long fluid line paths.

The two pumps are arranged on the input side of a switching device. The switching device is connected to the target apparatus on the output side.

The switching device can switch a communication path between the metering pump and the target apparatus, or alternatively switch a communication path between the flush pump and the target apparatus.

The switching device can, for example, be configured as a type of three-way valve. In particular, the switching device can be configured as a ball valve. However, other shutoff devices that can open or close fluid lines are also possible, such as conventional valves, gate valves or other suitable switching devices.

The switching device can adopt a first switch state in which it provides a communicative connection between the metering pump and the target apparatus. In this first switch state, in particular a communicative connection between the target apparatus and the flush pump is blocked, in particular fluid-tightly blocked.

In the second switch state, the switching device provides a communicative connection between the flush pump and the target apparatus. In this second switch state, a communicative connection between the target apparatus and the metering pump is blocked, in particular blocked in a fluid-tight manner, and further in particular blocked in a pressure-resistant, fluid-tight manner.

The switching device can be addressed directly or indirectly by the control device.

To perform a metering process, the metering device can, for example after receiving a media request command from a target apparatus, first address the switching device assigned to the target apparatus in order to set it to its first switch state, or at least to ensure that it adopts its first switch state.

The control device can then address the metering pump to remove the medium, in order to pump a predetermined amount of medium out of the container and convey it to just behind the switching device.

Strictly speaking takes place a delivery of the media quantity up to a point in the fluid line path that is arranged downstream of the switching device in the direction of delivery, which thus is located downstream of the switching device.

After performing the delivery of the medium, the control can address the switching device again and transfer it to its second switch state.

As soon as the switching device is in its second switch state, a communicative connection is established between the flush pump and the target apparatus. At the same time, the communicative connection between the metering pump and the target apparatus is blocked, in particular blocked in a fluid-tight and pressure-resistant manner.

The flush pump with its high capacity can then be addressed by the control device and, due to its higher capacity, flush the flushing agent or flushing medium, in particular water, further along the long fluid line paths to the target apparatus and, in particular, convey the volume of medium already located downstream of the switching device to the target apparatus.

The flush pump, which is optimally designed for the long fluid line paths, can quickly and efficiently deliver flushing medium to the target container.

This type of media delivery, in which the target apparatus, the so-called target, is or at least can be arranged far away from the metering device, is also known as target flushing among experts.

Because the metering device according to the invention comprises a metering pump and a flush pump arranged separately from the metering pump, and because these two different pumps can be optimally adapted to their respective technical requirements, the maintenance costs of a metering device according to the invention can also be kept low or significantly reduced compared to the prior art.

The switching device of the metering device according to the invention can also adopt a third switch state. In its third switch state, the switching device seals in particular all inlets against each other and also against the outlet. In particular, in this third switch state of the switching device, all ports of the switching device are blocked against each other in a fluid-tight and pressure-resistant manner.

In particular, after performing a target flushing, the control of the metering device can set the switching device to its third switch state and block all communication paths of this switching device from each other in a pressure-resistant and fluid-tight manner. As a result, on the one hand, the flush pump is safely separated from the target apparatus connected to this switching device and available for performing target flushing to other target apparatuses. At the same time, the metering pump connected upstream of the switching device is protected from any high static system pressure that may occur, for example, if the target apparatuses are arranged with a large height difference above the metering device.

A flush pump within the context of the invention is provided in particular by an electrical or electric motor-driven apparatus or other device capable of generating a delivery pressure, e.g. generate a suction pressure, to a flushing medium by a switching device to the target apparatus or to the different target apparatuses.

In a second alternative of the invention, the metering device according to the invention comprises a flushing device instead of a flush pump. For the purposes of the present invention, this is provided as an alternative to a flush pump. The flushing device is also able to provide a delivery pressure to deliver the medium.

The flushing device according to the invention, in contrast to a flush pump, uses the line pressure in the domestic water network in order to guide the flushing medium to the target apparatus with the aid of this line pressure.

If a flushing device is used, a separate electric or electric motor-driven apparatus, which generates an additional delivery pressure, is no longer required.

The invention thus makes use of either a flush pump or, alternatively, of a flushing device in the metering device according to the invention.

A flushing device within the context of the invention can, in particular, be connected to the domestic water network with the aid of a pipe shutoff device. In particular, a pipe shutoff device is used which is capable of transferring or passing-on the water line pressure contained in the domestic water network to fluid lines connected downstream.

A flushing device within the context of the invention can relate to a valve openable and closable by a control device or a manually operated valve. A flushing device in the context of the invention may also provide that an input side of a switching device is connected to the domestic water connection without the interposing of a controllable valve.

A metering device within the context of the present invention serves to deliver various chemicals that are present in fluid form and that are required to perform a washing or cleaning process. This also includes chemicals that can be used in disinfection processes or sterilization processes, in particular in the course of washing or cleaning processes.

The target apparatus within the context of the invention may in particular be provided by a washing machine. Other types of target apparatuses, e.g. dishwashers, washing or cleaning appliances, washing or cleaning equipment, washing or cleaning machines, are also considered as target apparatuses.

The invention is particularly advantageous for use when the target apparatus is one or more tunnel washers or tunnel dishwashers.

In such tunnel machines, belt machines or belt systems, for example, textiles are conveyed through a system for cleaning, e.g. using a screw conveyor, which has different processing or treatment zones. Here, there may be a requirement for different media to be supplied to different areas of this tunnel washer, in particular simultaneously, in order to perform efficient processing. With the metering device according to the invention, such a tunnel washer, which is also referred to as a conveyor belt washer, can be supplied with media efficiently and in a time-saving manner.

To avoid repetition, reference is made to the following prior art documents, all of which go back to the applicant and all of which disclose metering devices and methods: DE 10 2011 108 396A1, DE 10 2011 119 021A1, DE 10 2011 122 921A1, DE 10 2012 012 913A1, DE 10 2014 002 560A1, DE 10 2014 010 126A1, DE 10 2015 107 105A1, DE 10 2015 107 976A1, DE 10 2016 102 829A1, DE 10 2017 103 168B3, DE 10 2017 114 665A1, DE 10 2017 114 767A1, DE 10 2018 113 644A1, DE 10 2018 122 651A1, DE 10 2020 107 555A1, DE 10 2020 107 558A1, DE 10 2022 125 425 A1 and DE 10 2023 123 774A1 .

In order to avoid repetition, the contents of these patent applications are hereby incorporated in the contents of the present patent application, in particular for the purpose to include features from these publications into the content of the present application, if necessary also into the claims of the present application.

Exemplary embodiments of the present patent application can be combined with any features of the metering devices and metering methods of the above-mentioned documents from the prior art, including the applicant's publication mentioned at the beginning. Any of these combinations are within the scope of the invention.

In accordance with an advantageous embodiment of the invention, the metering device, in order to perform a metering process with the aid of the metering pump, causes a certain volume of medium to be removed from the container and this volume to be conveyed along a first fluid line portion in the direction of the container towards the target apparatus to a point downstream of the switching device. This embodiment of the invention enables the function of the metering pump to be separated from the function of the flush pump. The metering pump only delivers up to a point downstream of the switching device, but not up to the target apparatus. It can therefore be designed optimized for its intended use.

According to a further advantageous embodiment of the invention, the metering pump can be addressed by the control device for performing a metering process. This embodiment of the invention enables a particularly efficient design of a metering device according to the invention. In particular, a design is possible that only requires one control device, or at least makes it possible to use a centralized control.

According to a further advantageous embodiment of the invention, the flush pump of the control device can be addressed for performing a metering process. This embodiment of the invention enables a particularly efficient design of a metering device according to the invention. In particular, a design is possible which requires only one control device, or which in any case makes it possible to use a centralized control device.

According to a further advantageous embodiment of the invention, the metering device causes the volume to be conveyed along a second fluid line portion from the point downstream of the switching device to the target apparatus for performing the metering process with the aid of the flush pump. This embodiment of the invention enables an optimized design of the flush pump for the intended use on which the flush pump is based. As a result, a flush pump that is particularly suitable for this use can be designed or selected and used.

According to a further advantageous embodiment of the invention, the length of the second fluid line portion is more than 5 m, in particular more than 10 m, in particular up to multiple tens of meters. This embodiment of the invention enables the metering and delivering of media to target apparatuses that are arranged very far away from the metering device.

According to a further advantageous embodiment of the invention, the metering device is connected on the input side to at least one container which is filled with a medium. This embodiment of the invention enables a use of known parts and components.

According to a further advantageous embodiment of the invention, the metering device is connected on the input side to multiple containers. This embodiment of the invention enables metering and supply of different media to one or different target apparatuses. This embodiment also includes when not different media are arranged in the containers, but only one type of medium is arranged.

According to a further advantageous embodiment of the invention, the multiple containers are filled with different media. This embodiment of the invention enables the metering and supply of different media to one target apparatus or to different target apparatuses.

According to a further advantageous embodiment of the invention, the metering pump and the flush pump are designed differently and in particular comprise different pump types. This embodiment of the invention enables an optimized design of the pumps and a particularly advantageous design of the two pumps and a use of commercially available components.

According to a further advantageous embodiment of the invention, the metering pump is designed to deliver small volumes, in particular along fluid line portions which are kept short. This embodiment of the invention enables a particularly advantageous design of the metering pump, but also of the flush pump and a use of commercially available components.

According to a further advantageous embodiment of the invention, the flush pump is designed to deliver large volumes, in particular along fluid line portions designed to be long. This embodiment of the invention enables a particularly advantageous design of the two pumps and use of commercially available components.

According to a further advantageous embodiment of the invention, the metering pump is a peristaltic pump. This embodiment of the invention makes it possible to use conventional pumps and components.

According to a further advantageous embodiment of the invention, the flush pump is provided by a diaphragm pump or by a centrifugal pump. This embodiment of the invention makes it possible to use conventional pumps and components.

Alternatively, the metering device has a flushing device that uses the line pressure prevailing in the domestic water network to deliver the flushing medium to the target apparatus. The flushing device can be designed without its own delivery drive and can, for example, ensure that the switching devices are connected directly to the domestic water supply for the purpose of performing a target flush. The line pressure prevailing there can be used to deliver the flushing medium to the target apparatus and thus for performing the target flush.

In these exemplary embodiments, the flushing device advantageously has a separating device that reliably prevents chemical or bacteriological contamination of the domestic water network. This separating device is designed to transfer or let through the line pressure of the domestic water network to connected downstream fluid lines, so that this line pressure can be used for delivering the flushing medium to the target apparatus.

According to a further advantageous embodiment of the invention, the metering device comprises multiple switching devices. This embodiment of the invention enables delivering and the metering of media to different target apparatuses. In particular, a delivery of media and/or a delivery of flushing medium can be performed simultaneously to multiple target apparatuses. In particular, the flush pump and the metering pump can be operated simultaneously or overlapping in time in accordance with the invention.

According to a variant of this embodiment of the invention, the plurality of switching devices are combined to form a unit, in particular a structure. Multiple switching devices can, for example, be arranged along a straight line, and/or e.g. be arranged or attached to a common carrier or frame. This simplifies the design and enables advantages in the electrical wiring and/or in the arrangement of fluid lines and/or electrical lines. In this way, it is also possible to achieve a particularly material-saving arrangement as well as a compact design of multiple switching devices.

However, this embodiment also makes it possible for these multiple switching devices to be arranged separately, i.e. multiple switching devices are arranged at a distance from each other, for example.

The switching devices can be addressed via individual or common signal or control lines from a control device of the metering device or from a sub-control device. For example, the signal or control lines can be arranged in the form of a star connection.

Alternatively, the invention also relates to that the signal lines are designed in the manner of a bus line or are multicore.

According to a further advantageous embodiment of the invention, the metering device comprises a mixing distributor device, with the aid of which a selected one of the plurality of switching devices can be communicatively connected to the metering pump. This embodiment of the invention enables a use of conventional mixer-distributor devices, in particular of the applicant. In particular, a mixer-distributor device can be used, as disclosed in the documents described at the beginning and going back to the applicant, to which reference is made in order to avoid repetition.

According to a further advantageous embodiment of the invention, the metering device is connected to multiple target apparatuses. This embodiment of the invention enables the supply of media to multiple target apparatuses.

According to a further advantageous embodiment of the invention, the metering device is connected to the domestic water connection on the input side via at least a pipe shutoff device. This embodiment of the invention enables a use of conventional parts and components and safe operation. In particular, this embodiment of the invention makes it possible to provide water for the purpose of flushing the fluid line paths to the point downstream of the switching device.

According to a further advantageous embodiment of the invention, the switching device is provided by a motor-driven ball valve. This embodiment of the invention enables the use of conventional parts and components and safe operation.

According to a further advantageous embodiment of the invention, the switching device is provided by a multi-way valve or 3/3-way valve. This embodiment of the invention enables the use of conventional parts and components and safe operation.

According to a further advantageous embodiment of the invention, the switching device blocks the communicative connection between the metering pump and the target apparatus in its second switch state, in particular in a pressure-resistant manner. This embodiment of the invention enables a particularly safe mode of operation of the device according to the invention.

According to a further advantageous embodiment of the invention, in a third switch state, the switching device blocks all inlets and the outlet from each other in a fluid-tight manner and, in particular, blocks the outlet and the inlet from each other. This enables particularly safe operation of the metering device.

According to a further aspect, the invention relates to a method according to claim 22.

The object underlying the invention is to provide a method with which the metering and delivering of media can be performed efficiently, safely and cost-effectively even if long fluid lines are arranged between the container containing the medium and the target apparatus, or if the medium has to be conveyed over a large height difference.

The invention achieves this object with the features of claim 22.

In order to avoid repetition, for further details of the operation of the method and the meaning of the features of this claim, reference is made to the above comments on claims 1 to 21.

According to a further aspect, the invention relates to a method according to claim 23.

The object underlying the invention is to provide a method with which the metering and delivering of media can be performed efficiently, safely and cost-effectively even if there is a gap between the container containing the medium and the target apparatus, long fluid lines are arranged, or if the medium has to be delivered over a large height difference.

The invention achieves this object with the features of the claim 23.

To avoid repetition, reference is hereby made to the above explanations of claims 1 to 22.

According to a further aspect, the invention relates to a metering device according to claim 24.

Based on the metering device of the prior art described at the beginning, the object of the invention is to provide a metering device that ensures safe, reliable and fast delivery of media, can be used even with long line lengths between the container and the target apparatus and/or where there are large height differences to be overcome along the fluid lines.

The invention achieves this object with the features of claim 24.

In order to avoid repetition, reference is made to the above explanations of claims 1 to 21 with regard to the description of the operation of the method and the meaning of the features of these claims.

According to claim 24, the metering device provides a third pump, the so-called dilution pump. The dilution pump can be used for certain media which require dilution with water in order to improve their deliverability, it must be diluted with additional flushing medium, namely water, for the purpose of pumping to a point downstream of the switching device.

A dilution pump can be provided for this purpose, which can be addressed, in particular by the control device of the metering device, in order to supply additional flushing water for the purpose of dilution if required.

In this embodiment, the switching device can be designed in such a way that it can adopt a first switch state in which it establishes a communicative connection between the metering pump, the dilution pump and the target apparatus. In particular, the dilution pump can be operated at the same time as the metering pump or at a point in time immediately after the metering pump has completed the metering process.

In this variant, the metering pump is designed to be pressure-tight against the delivery pressure generated by the dilution pump.

The dilution pump can be connected to the fluid line via a dilution bypass, in particular downstream of the metering pump. In one exemplary embodiment of the invention, the dilution bypass can be opened or closed via a valve that can also be addressed by the control device of the metering device.

According to a further aspect, the invention relates to a metering device according to claim 25.

Based on the prior art described above, the object of the invention is to provide a metering device that enables safe, reliable and fast delivery of media even with long line lengths between the container and the target apparatus and/or with large height differences to be overcome along the fluid lines.

The invention achieves this object with the features of the claim 25.

The principle of this invention is to make available a metering device that can also efficiently deliver media that require dilution with a flushing agent, i.e. water, at an early stage.

To this end, in particular, a dilution bypass branches off from the fluid line arranged between the flush pump and the switching device. The dilution bypass meets the fluid line, in particular between the metering pump and the switching device, in particular at a point directly downstream of the metering pump. The dilution bypass can be switched on or remain switched off, i.e. opened or closed in particular via a valve that can be addressed by the control device. It can be switched on as required for example, only when a specific medium is being pumped that requires additional dilution.

As in a metering device according to claim 1, the switching device can have two switch states. In a first switch state, it communicatively connects the metering pump to the target apparatus and in the second switch state, it communicatively connects the flush pump to the target apparatus.

In the first switch state, however, the switching device also connects the dilution bypass communicatively with the target apparatus, provided that the valve—if a valve is provided—is open.

According to a further aspect, the invention relates to a metering device according to claim 26.

Based on the prior art described at the beginning, the object of the invention is to provide a metering device that can be used even with long line lengths between the container and the target apparatus and/or with large height differences to be overcome along the fluid lines and enables safe, reliable and fast delivering of media.

The invention achieves this object with the features of claim 26.

This is where the dilution bypass meets the fluid line system for the delivery of the media directly downstream of the metering pump, or in any case upstream of the switching device.

According to an alternative of this invention, the dilution bypass meets the fluid line in the area of the switching device.

In this case, the switching device can be designed so that a short dilution bypass, e.g. equipped with a throttle, is provided, that leads directly to the switching device or is provided directly on the switching device.

Here too, the flush pump can feed the corresponding dilution bypass(es) with flushing medium, i.e. apply it/them with flushing medium. Here, too, no separate pump is required in addition to the metering pump and the flush pump.

It is of importance for the invention according to claims 24 to 26 that the metering pump can be operated to deliver media, and at the same time a dilution medium, namely water, can be supplied via a dilution bypass, either from a separate dilution pump or from the flush pump.

Further advantages of the invention are apparent from the uncited subclaims and from the following description of the exemplary embodiments shown in the drawings.

The Figures show in:

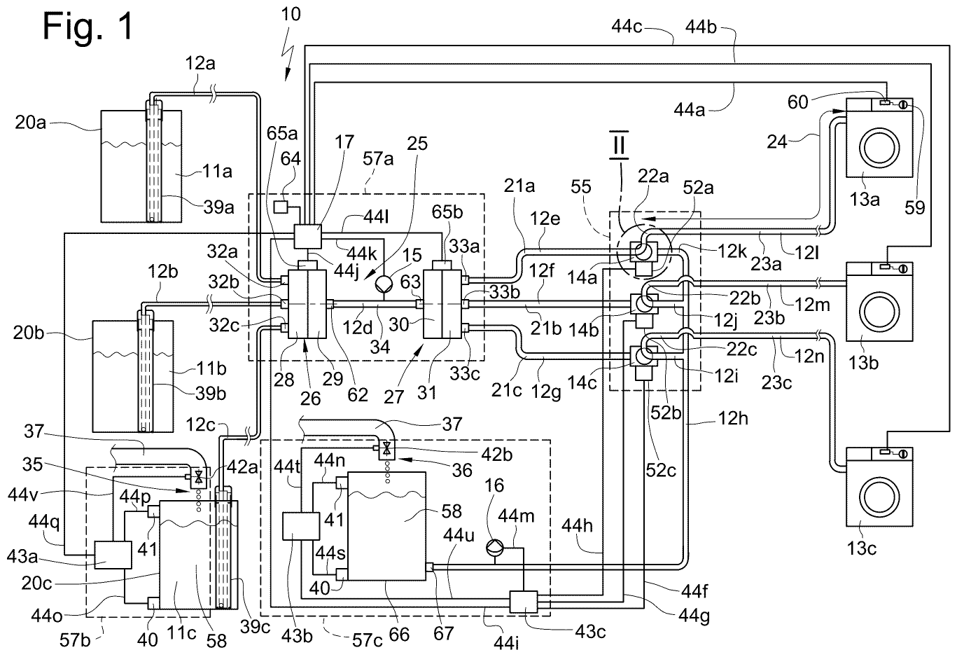

FIG. 1 in a schematic, partially cutaway, block circuit-type diagram view of a first exemplary embodiment of a metering device according to the invention, with two containers connected on the input side, which are filled with different media and with a container connected on the input side with water as flushing medium, as well as with a mixing distributor device, with a metering pump, and with a plurality of fluid lines via which the metering device can be connected to three target apparatuses, wherein each target apparatus is assigned a switching device and with a flush pump which is arranged upstream of the switching devices and which is supplied by a separate water reservoir,

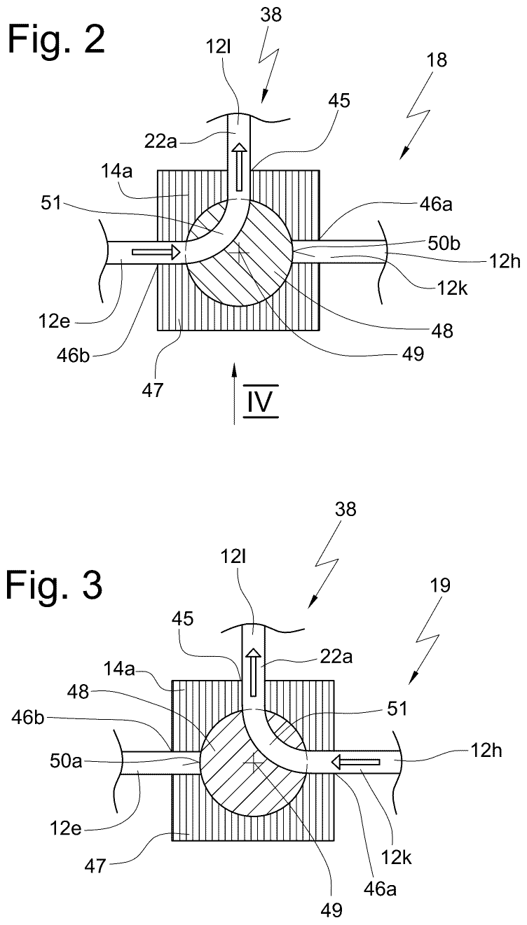

FIG. 2 in an enlarged schematic view, approximately in accordance with partial circle II in FIG. 1, a schematic diagram of the principle of a switching device with a valve body for illustrating the switching paths,

FIG. 3 the switching device of FIG. 2 with a modified valve body position,

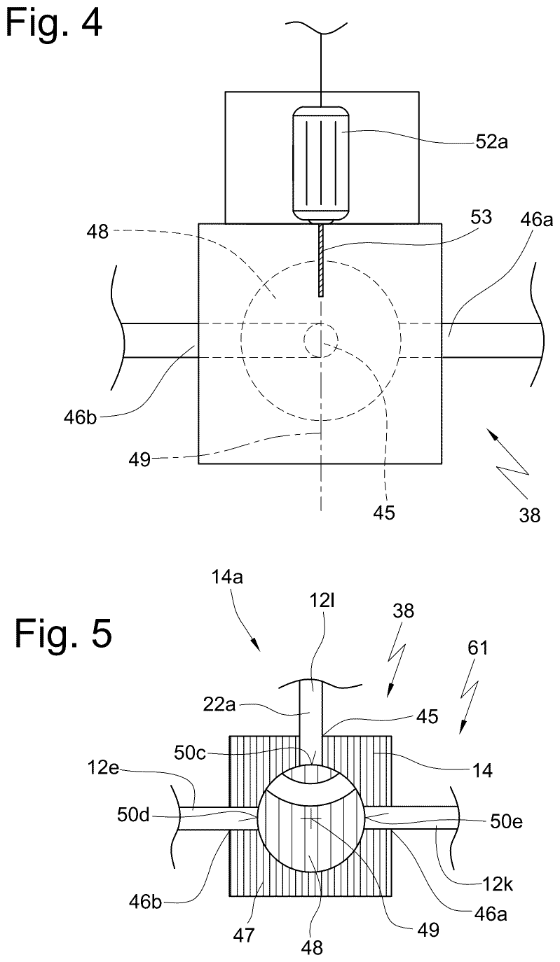

FIG. 4 in a partially sectional schematic view, roughly along viewing arrow IV in

FIG. 3, the switching device in FIG. 3 in the partially-sectional, schematic side view for illustrating the interaction of a motor with the valve body,

FIG. 5 the switching device of FIG. 2 with a modified position of the valve body, wherein switching device is shown in a third switch state, in which the entirety of inlets and the outlet are shut off relative to one another in a fluid-tight, in particular pressure-tight manner,

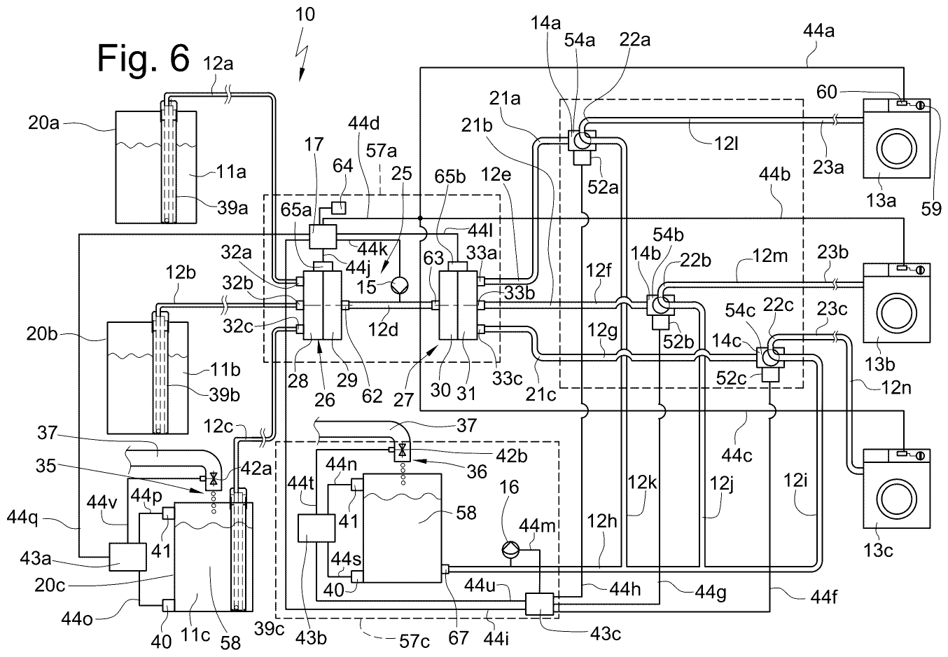

FIG. 6 another exemplary embodiment of a metering device according to the invention as shown in FIG. 1, in in which the three switching devices are arranged individually,

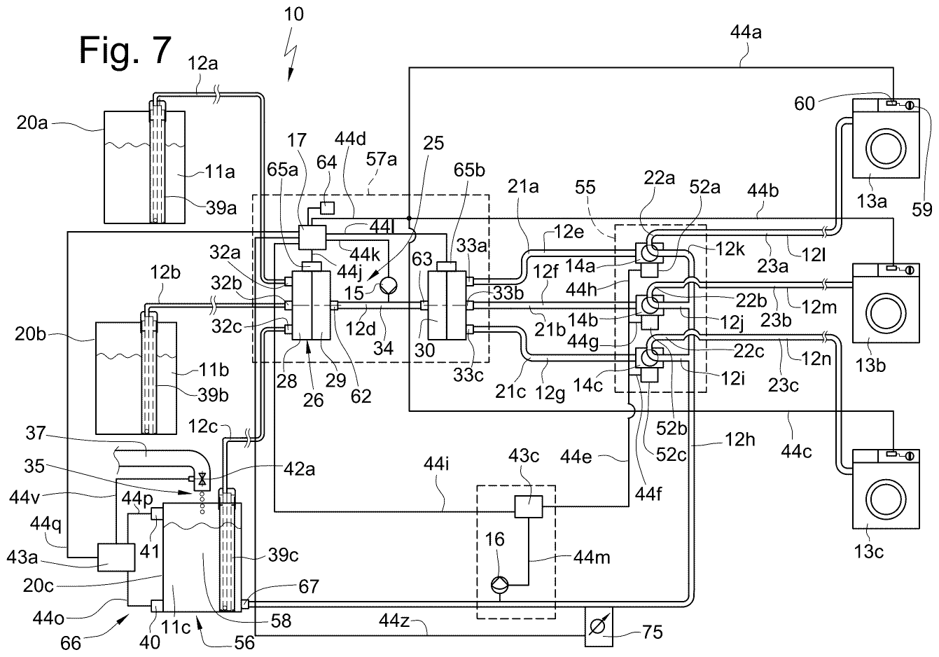

FIG. 7 another exemplary embodiment of a metering device according to the invention in an illustration according to FIG. 1, in which a common pipe shutoff device and a common water reservoir are provided,

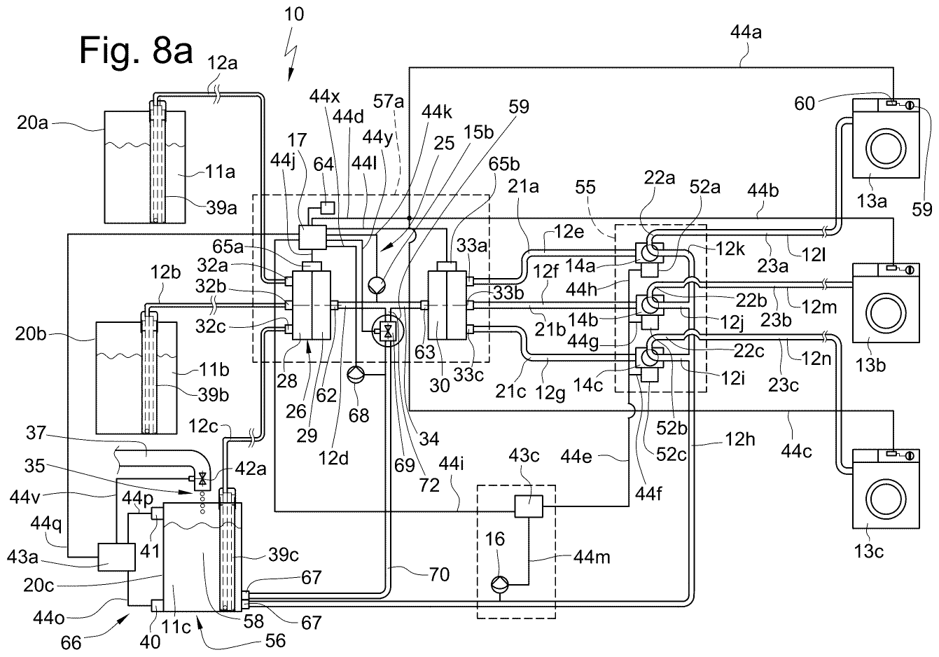

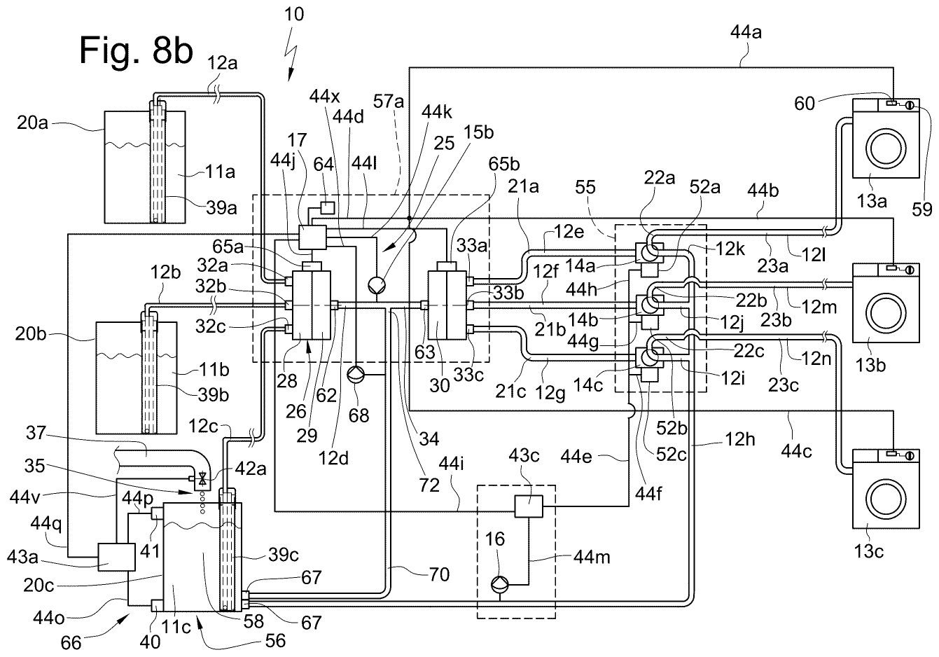

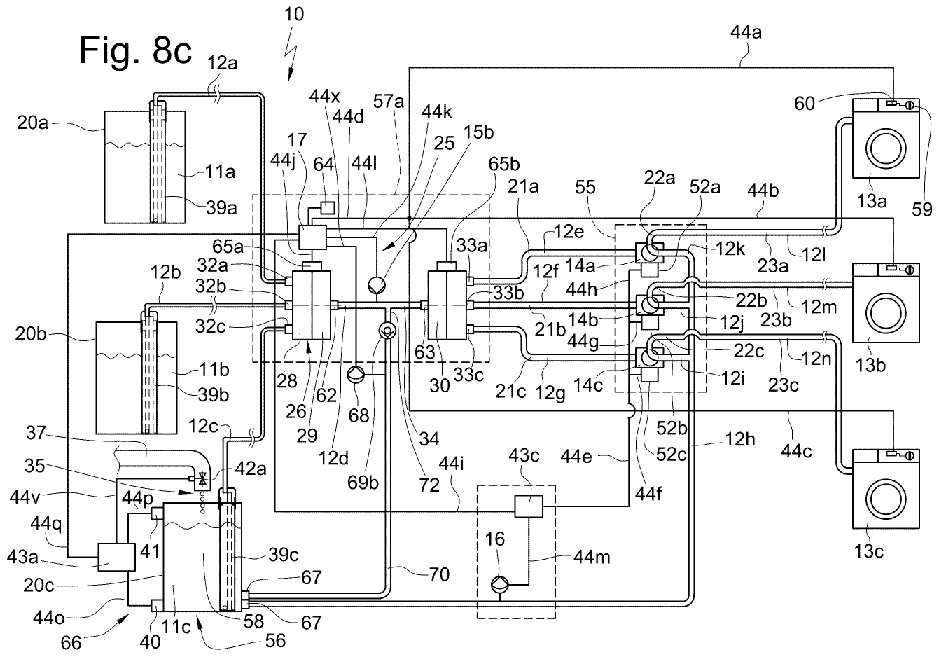

FIG. 8a in an illustration according to FIG. 1, another exemplary embodiment of a metering device according to the invention with an additional dilution pump, which can be switched on via a switchable valve,

FIG. 8b another exemplary embodiment of a metering device according to the invention in an illustration according to FIG. 8a, in which the switchable valve is omitted,

FIG. 8c another exemplary embodiment of a metering device according to the invention in an illustration according to FIG. 8a, wherein instead of a switchable valve, a valve, in particular a passive non-return valve is provided,

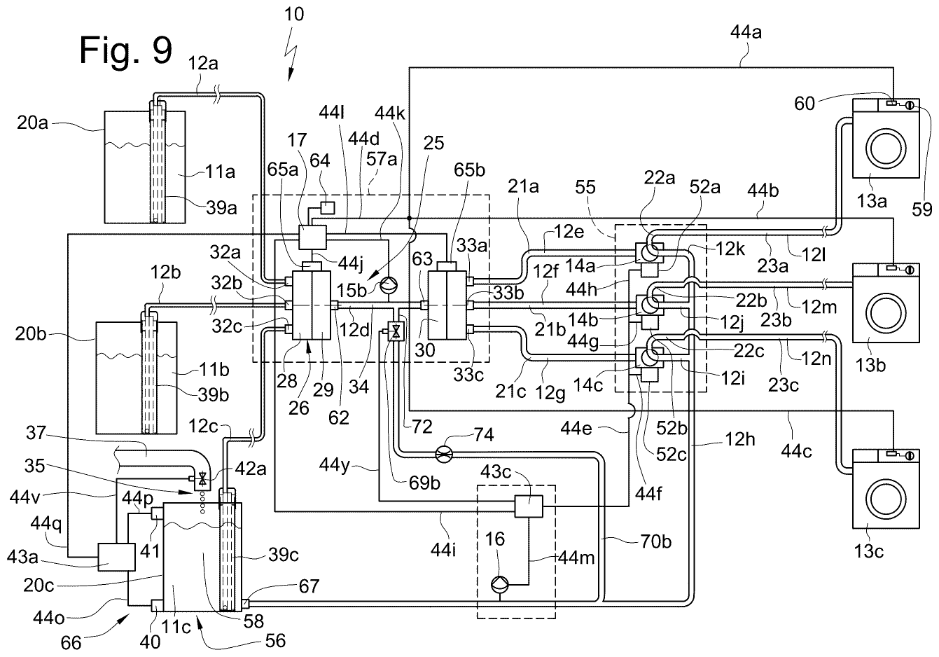

FIG. 9 another exemplary embodiment of a metering device according to the invention in an illustration according to FIG. 1, wherein the flush pump has a dilution bypass,

FIG. 10 another exemplary embodiment of a metering device according to the invention in an illustration according to FIG. 1, wherein the switching devices are each designed as a four-way valves and comprise a dilution bypass,

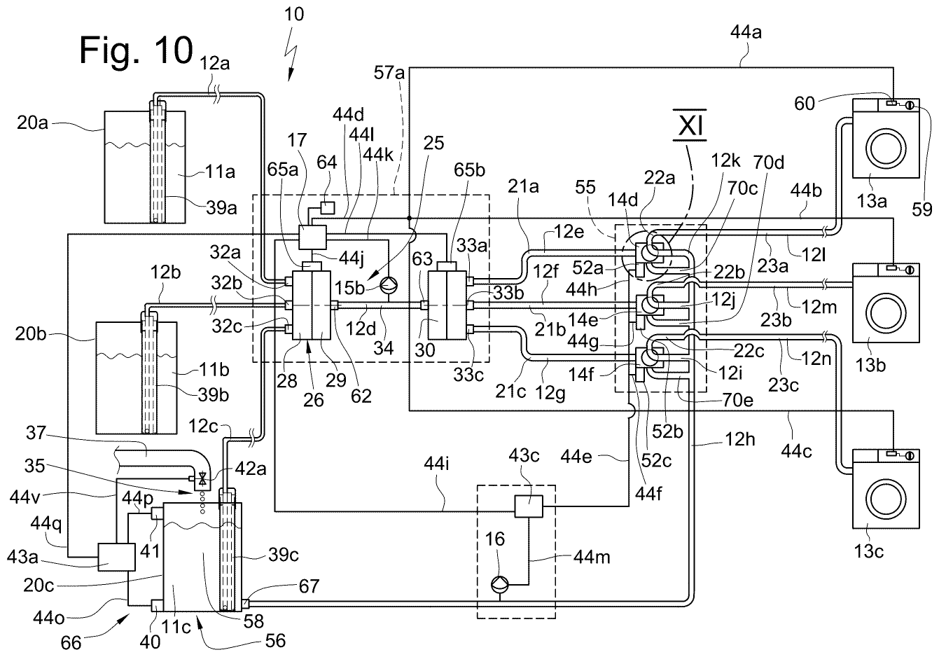

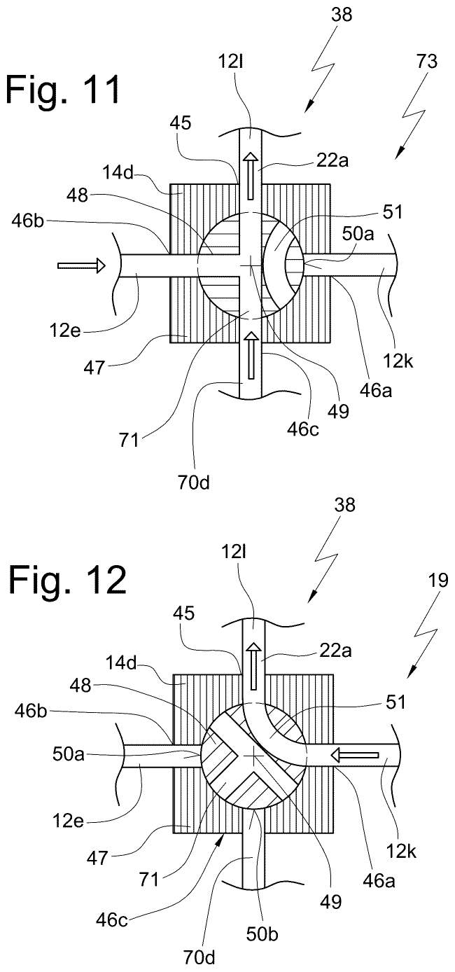

FIG. 11 in a schematic diagram according to FIG. 2, a switching device of the exemplary embodiment of FIG. 10, which is designed as a 4-way-switching device, roughly according to an illustration of the partial circle XI in FIG. 10,

FIG. 12 the switching device according to FIG. 11 in a changed position of the valve body,

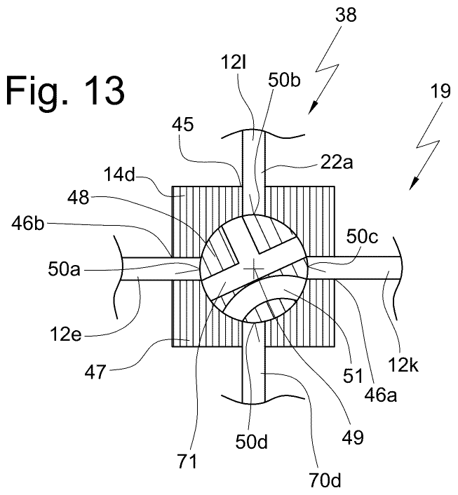

FIG. 13 the switching device of FIG. 11 in another, changed position of the valve body,

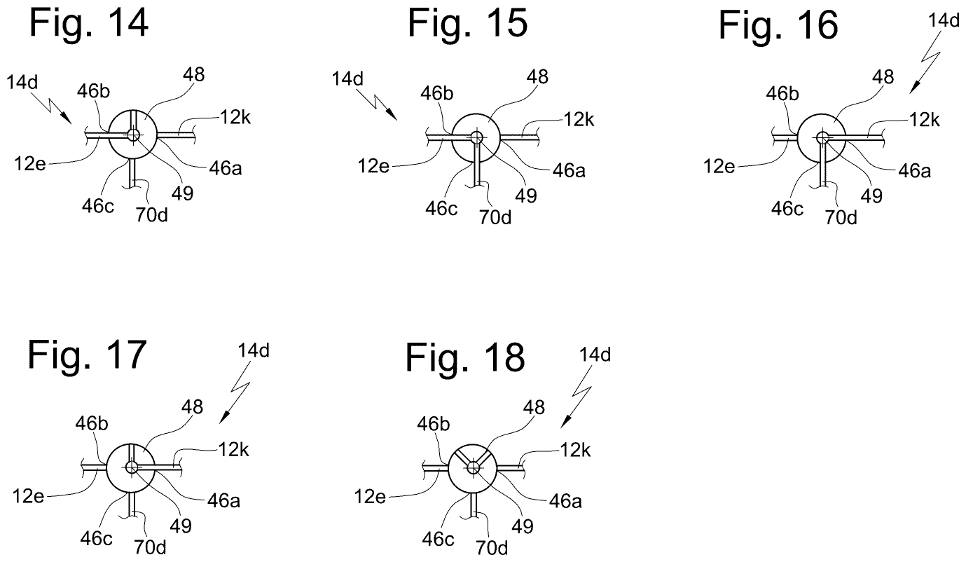

FIG. 14 in an illustration similar to that of FIGS. 11 to 13, another exemplary embodiment of a switching device, which can assume five different switch states, in a first switch state, wherein the switching device has a valve body in the form of a ball which has three channel sections perpendicular to one another, wherein the output channel (not shown) is arranged emerging from the paper plane in the direction of the viewer's gaze, wherein FIG. 14 shows a switch state in which only medium is delivered,

FIG. 15 the exemplary embodiment of FIG. 14 in a changed switch state,

FIG. 16 the exemplary embodiment of FIG. 15 in a changed switch state,

FIG. 17 the exemplary embodiment of FIG. 16 in a changed switch state,

FIG. 18 the exemplary embodiment of FIG. 17 in a changed switch state,

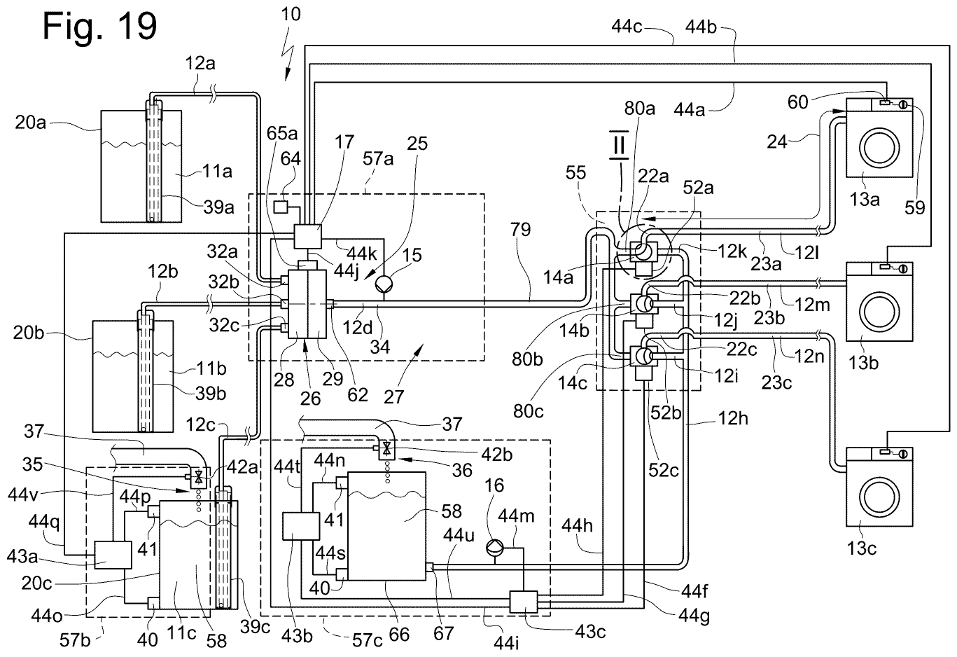

FIG. 19 another exemplary embodiment of a metering device according to the invention in an illustration according to FIG. 1, wherein a second part of a mixing distributor device is omitted and wherein the line routing between the metering pump and the switching devices is changed,

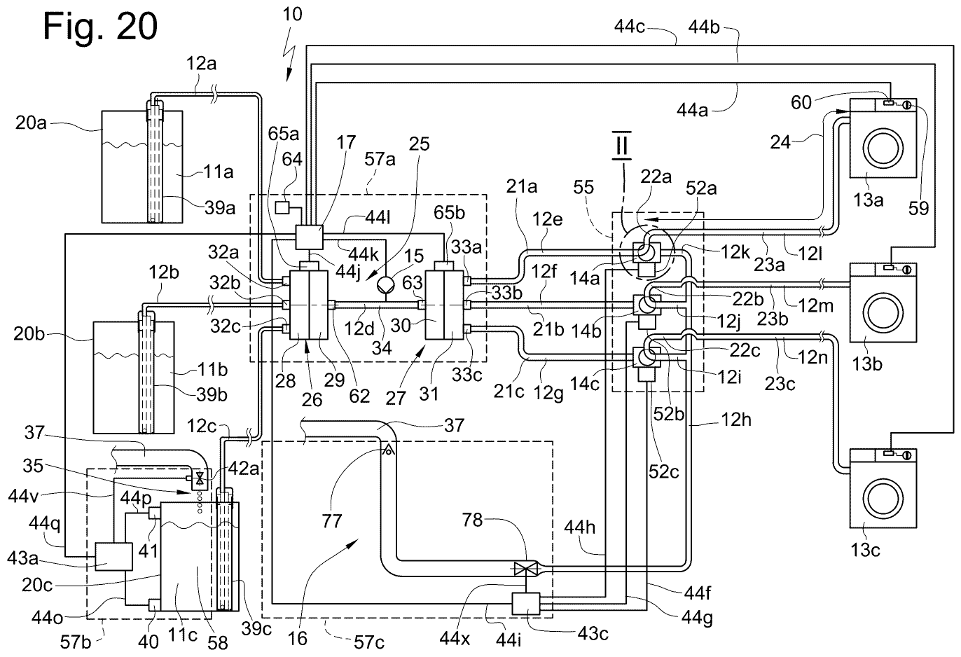

FIG. 20 another exemplary embodiment in an illustration according to FIG. 1, wherein instead of a flush pump a flushing device is provided, which uses the line pressure of the domestic water network to deliver flushing medium to the target apparatus,

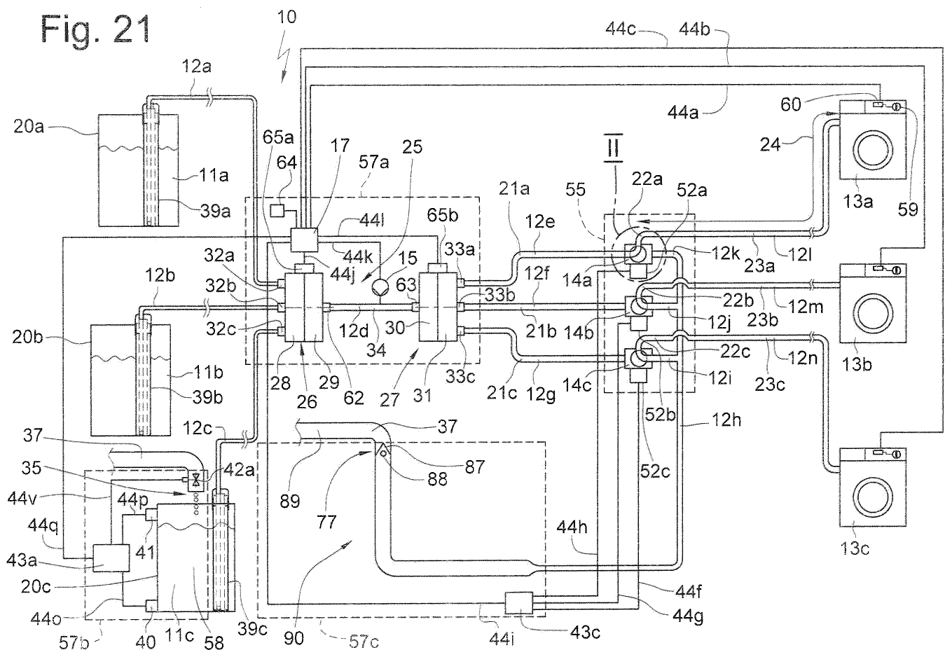

FIG. 21 another exemplary embodiment as shown in FIG. 20, wherein a modified flushing device is provided, and

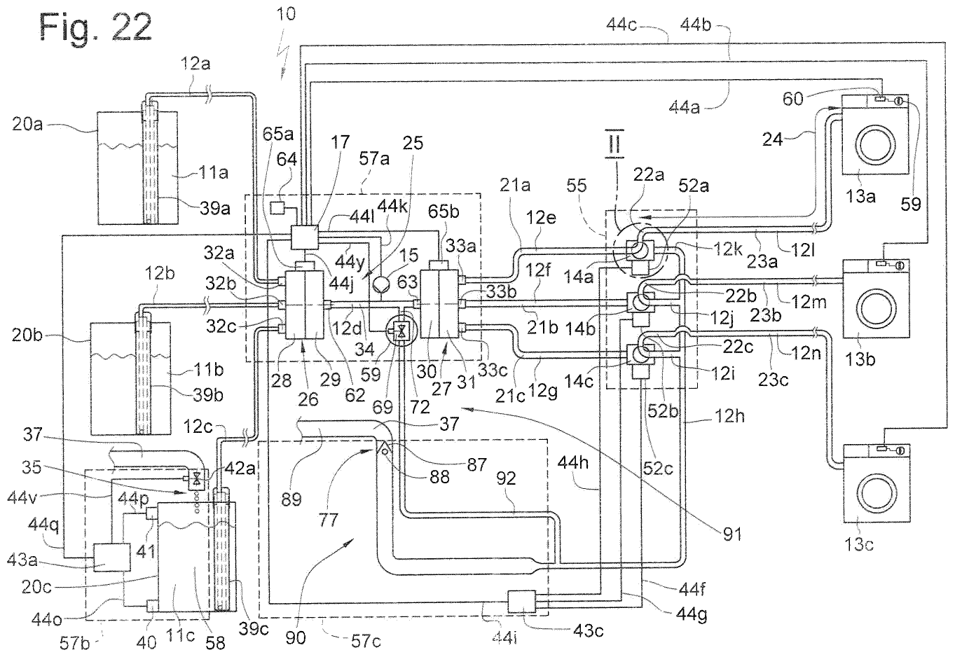

FIG. 22 another exemplary embodiment in an illustration according to FIG. 21, wherein starting from the exemplary embodiment in FIG. 8a, the dilution pump provided there is replaced by a dilution device that is connected to the domestic water network, and the dilution pump is connected to the domestic water network and which uses the line pressure in the domestic water network to deliver the flushing medium to the target apparatus.

Exemplary embodiments of the invention are described by way of example in the following description of the Figures, also with reference to the drawings. For the sake of clarity—also insofar as different exemplary embodiments are concerned—the same or comparable parts or elements or regions are designated with the same reference characters, sometimes with the addition of lowercase letters.

Features that are only described in relation to one exemplary embodiment can also be provided within the scope of the invention in any other exemplary embodiment of the invention. Such modified exemplary embodiments—even if not shown in the drawings—are included within the scope of the invention.

All disclosed features are in itself essential to the invention. The disclosure of the application hereby also includes the entirety of the disclosure content of the associated priority documents (copy of the previous application) as well as the cited publications and the described prior art devices, also for the purpose of incorporating one or more features of these documents in one or more claims of the present application.

A first exemplary embodiment of a metering device according to the invention is denoted in its entirety by the reference character 10 in FIG. 1.

The metering device 10 can include a plurality of parts and components. In particular, it can have a compact design and integrate all parts and components. However, it can also, as shown in FIG. 1, comprise multiple functional units 57a, 57b, 57c, which are connected to each other and which as a whole form the metering device 10.

The metering device 10 is supplied with media 11a, 11b, 11c on the input side. The media 11a, 11b are different media, and in particular different chemicals, which are required, for example, for a washing or cleaning procedure in a target apparatus 13a, 13b, 13c.

The media 11a and 11b can, for example, be different cleaning agent or detergent components.

The medium 11c can be a flushing medium 58, in particular water.

The media 11a, 11b, 11c are each located in a container, 20a, 20b, 20c, in a so-called bundle.

A removal of the medium 11a, 11b, 11c from the container 20a, 20b, 20c can be carried out with the aid of a suction lance 39a, 39b, 39c, each of which is connected to an input or inlet 32a, 32b, 32c of the metering device 10 via a fluid line 12a, 12b, 12c.

The metering device 10 is designed for delivering the media 11a, 11b, 11c in a predetermined quantity via fluid lines to a selected target apparatus 13a, 13b, 13c in each case.

In the exemplary embodiment of FIG. 1, the target apparatuses 13a, 13b, 13c are designed as commercial washing machines 13a, 13b, 13c. Also other target apparatuses, such as commercial dishwashers, or washing or cleaning installations, in particular tunnel installations, may be considered in within the context of use of the invention.

In the exemplary embodiment of FIG. 1, the target apparatus 13a has a program selection switch 59 with which, for example, a specific washing or cleaning program can be set. Moreover, the target apparatus 13a has the control device 60, which is connected to the program selection switch 59.

If the target apparatus 13a performs a washing process or cleaning process, and at a certain point in time a medium 11a is required in a certain quantity, the target apparatus 13a can transmit a corresponding medium request command to a control device 17 of the metering device 10 via the control device 60 and via the signal line 44a.

The metering device 10 can have a storage 64 in which information on the metering command is stored.

As a result of receiving a media request command, the control device 17 can address a switching device 14a, which will be explained later, via a signal connection line 44h, and address a drive 65a via a signal connection line 44j, which acts on a first part 26 of a mixing distributor device 25.

Furthermore, the control device 17 can be controlled via a signal line 44l in order to address a drive 65b of a second part 27 of the mixing distributor device 25.

The first part 26 of the mixing distributor device 25 comprises an input disk 28 and an output disk 29, which are displaceable, in particular rotatable relative to each other by the drive 65. As a result of a relative rotation, one of the inlets 32a, 32b, 32c in each case can be brought into communicative connection with the outlet 62 thus providing the desired communication path between the desired medium 11a, 11b, 11c and the outlet 62 of the first part 26. The second part 27 of the mixing distributor device 25 has an input disk 30 with an inlet 63 and an output disk 31, in particular a rotatable output disk, comprising multiple outlets 33a, 33b, 33c.

In the different relative rotational positions of the disks 30, 31, the inlet 63 of the second part 27 of the mixing distributor device 25 can be brought into communicative connection with a selectable outlet 33a, 33b, 33c. In this way, the communication path can be switched to the desired target apparatus 13a.

As a result of the control device 17 receiving a media request command from the target apparatus 13a, the control device 17 may, for example, cause a communication path to be switched between the container 20a and the outlet 62 and the target apparatus 13a.

All other communication paths between the containers 20a, 20b, 20c and the target devices 13a, 13b, 13c are then blocked.

Now the control device 17 can act on the metering pump 15 via a signal line 44k and address it. The metering pump 15 can, for example, be designed as a peristaltic pump 15, and act on the fluid line portion 12d, which is also referred to as intermediate line portion 34, and for example generate a suction pressure therein.

The metering pump 15 is designed as a peristaltic pump, for example. It is used for the precise delivery of predetermined defined volumes or quantities of medium.

The metering pump 15 delivers the predetermined amount of medium 11a into the fluid line portion 12e and on to downstream of a switching device 14a to be explained later.

For the subsequent flushing of the fluid line paths 12d, 12e and in particular of the passage channels (not shown) in the two parts 26 and 27 of the mixing distributor device 25, the metering device 10 can address the drive 65a via the control device 17 in such a way that subsequent to each delivery of a medium 11a, 11b the water reservoir 20c is always brought into communicative connection with the intermediate line portion 34, and the line paths are flushed as a result of the metering pump being addressed anew.

The metering device 10 is configured in such a way that the volume of medium 11a to be delivered in any case reaches a point 22a or position in the fluid line portions which is downstream of the switching device 14a as a result of the delivery work of the metering pump 15.

This position is denoted with the reference character 22a in FIG. 1.

It should be noted that the point 22a can also be located further downstream of the switching device 14a than shown.

The above-described delivery of the medium 11a in a predetermined quantity, up to a point 22a downstream of the switching device 14a, requires that the switching device 14a has previously been addressed by the control device 17 via the signal line 44h and 44i via the sub-control device 43c and set to a first switch state 18, in which it has brought the fluid line portion 12e into communicative connection with the target apparatus 13a.

It should be noted that this first switch state 18 is only shown for the switching device 14a in FIG. 1.

The two remaining switching devices 14b, 14c are shown in FIG. 1 in their second switching position.

It should be noted that, as shown in FIG. 1, the sub-control device 43c is connected to the control device 17 of the metering device 10 via a signal and connection line 44i.

In an alternative exemplary embodiment, not shown in the Figures, the control device 17 and the sub-control device 43c may be provided by a common component.

After the desired volume of medium 11a has been conveyed to the point 22a, the control device 17 can—in particular directly or with the aid of the sub-control device 43c—cause the switching device 14a to switch to a second switch state 19.

While FIG. 2 shows the first switch state 18, FIG. 3 shows the second switch state 19.

In the second switch state 19, the communicative connection is between the fluid line portion 12e and the target apparatus 13a is blocked. Instead, in the second switch state 19 of the switching device 14a, there is a communicative connection between the fluid line portion 12h or the fluid line portion 12k and the target apparatus 13a.

As shown in FIG. 1, the fluid line portion 12h or 12k is connected to a water reservoir 66. To deliver the water 58 from the water reservoir 66 via the fluid line 12h, 12k and in particular via the fluid line portion 12l, to the target apparatus 13a, a flush pump 16 is provided, in particular with a high capacity. The flush pump 16 is connected in particular to the sub-control device 43c via the signal connection line 44m and can be addressed by the sub-control device 43c.

As already shown above, the flush pump 16 can either be addressed indirectly by the control device 17 via the sub-control device 43c, or can be addressed directly by the control device 17.

The flush pump 16 is more powerful than the metering pump 15 and can, in particular, generate higher pump capacities and, for example, higher delivery pressures.

Between the switching device 14a and the target apparatus 13a, the fluid line portion 12l, the so-called second line portion, has a length 24.

The length 24 can be more than 5 m or more than 10 m, in certain situations even more than 50 m, sometimes even up to 80 m.

After the flush pump 16 has conveyed the predetermined volume of medium 11a to the point 22a, that is, the medium has merely covered a relatively short line delivering distance, the flush pump 16 can take over the further delivering of the medium 11a to the target apparatus 13a, which is arranged far away, after transferring the switching device 14a from its first switch state 18 to its second switch state 19.

In addition to long lengths 24 of the fluid lines 12l, large height differences can also be overcome by the high-performance flush pump 16, for example.

FIG. 1 shows the switching device 14a in its first switch state 18 and the two remaining switching devices 14b, 14c in their second switch state 19, in which they each unblock the communicative connection between the target apparatus 13b, 13cand the associated flushing line portion 12j, 12i and of the collective flushing line 12hrespectively. In the second switch state 19, flushing to the target apparatuses 13b, 13c can take place.

If one of the switching devices 14a, 14b, 14c is in its second switching position 19, the respective communicative connection to the upstream line portion 12e, 12f, 12g, which leads to the mixing distributor 25, and also the respective communicative connection to the metering pump 15 is blocked in a fluid-tight manner.

The higher-performance flush pump 16, which, for example, also has a high pressure is therefore decoupled from the respective input side of this switching device 14a, 14b, 14c when one of the switching devices 14a, 14b, 14c is in its second switching position 19.

This in particular prevents that pressure originating from the output side builds up at the second part 27 of the mixing distributor 25.

In one exemplary embodiment, the metering device 10 according to the invention allows simultaneous or parallel operation of the metering pump 15 and the flush pump 16. Parallel operation is permitted in particular if, for example, one of the switching devices, e.g. the switching device 14a, is in a first switching position, and the other switching devices, for example the switching devices 14b and 14c, are in a second switching position. Then, by operating the flush pump 16 through the switching devices 14b and 14c, a target flushing towards the target apparatus 13b and 13c, and at the same time metering of the medium 11a through the first switching device 14a to the fluid line portion 12l can be made by operating the metering pump 15.

In particular, the metering pump 15 and the flush pump 16 can thus be operated simultaneously.

Compared to the prior art, this allows for considerably saving time, since, for example, multiple target apparatuses 13a, 13b, 13c can be fed simultaneously. For example, a flushing to a target apparatus, e.g. towards the target apparatus 13a, can take place, while media is metered by parallel operation of the metering pump 15 in one direction towards another target apparatus, e.g. towards the target apparatus 13b.

It should be noted that the flush pump 16 can be designed with such a high capacity that it can carry out the target flushings to multiple target apparatuses 13a, 13b, 13c at the same time.

The metering pump 15 can be optimized according to its technical requirements and designed in such a way that small volumes of medium 11a, 11b, 11c are metered very precisely at only small capacities.

The flush pump 16, on the other hand, can be designed according to its different technical requirements, for example, to pump large volumes of flushing medium quickly over long distances at higher pressures.

The exemplary embodiment of FIG. 1 shows three target apparatuses 13a, 13b, 13c and three switching devices 14a, 14b, 14c. However, the number of target apparatuses is arbitrary. The number of switching devices 14a, 14b, 14c preferably corresponds to the number of target apparatuses 13a, 13b, 13c.

FIG. 1 illustrates that the container 20c serves as a water reservoir 66 and contains water 58. For this purpose, the container 20c is connected to the domestic water connection 37 via a pipe shutoff device 35. The pipe shutoff device 35 includes a water valve 42a, which can be addressed by a sub-control device 43a via a control line 44v. The sub-control device 43a can, but must not necessarily, be connected to the control device 17 of the metering device via a signal and connection line 44q.

The pipe shutoff device 35 comprises a first, lower filling level sensor 40 and a second, upper filling level sensor 41.

These sensors are connected to the sub-control device 43a via signal lines 44p, 44o. It is decisive here that the pipe shutoff device 35 comprises a free-fall section, so that the domestic water connection 37 cannot be chemically or bacteriologically contaminated.

If it is detected at the lower filling level sensor 40 that the supply of water 58 in the container 20c is running low, the sub-control device 43a addresses the valve 42a to open it and water is added until the lower filling level sensor 40 detects water, i.e. until the reservoir 66 is filled again.

The sub-control device 43a then actuates the valve 42a in the closing direction. The now filled reservoir 66 can then be successively emptied.

In exemplary embodiments of the invention, the functional unit 57b can be designed independently of the metering device 10 and function independently of the latter. Preferably, however, the functional unit 57b is a component of the metering device 10 and/or is connected thereto.

Water 58 is removed from the container 20c by the metering device 10, in particular via a suction lance 39c. Water 58 as a flushing medium is delivered by the mixing distributor 25, in particular each time after a medium 11a, 11b has been delivered to flush the line paths as far as to the point 22a downstream of the switching device 14a.

FIG. 1 shows an exemplary embodiment in which two containers 20a, 20b containing different media 11a, 11b are connected to the metering device 10. The scope of the invention also relates to a case in which a different number of containers 20a, 20b with different media 11a, 11b or even with the same media are connected.

FIG. 1 illustrates an exemplary embodiment in which the mixing distributor device 25b is flushed each time after medium has been delivered. In particular, flushing of the mixing distributor 25 and the fluid line portions 34, 12e, 12f, 12g always takes place up to the respective point 22a, 22b, 22c downstream of the corresponding switching device 14a, 14b, 14c before the respective switching device 14a, 14b, 14c is moved from its first switching position 18 to its second switching position 19.

As shown in FIG. 1, the flush pump 16 is connected via the fluid line portion 12h to a water reservoir 66, which has its own pipe shutoff device 36. This functions in the same way as the already explained first pipe shutoff device 35 in the exemplary embodiment of FIG. 1.

In further exemplary embodiments, the flush pump 16 can also be connected directly to a domestic water connection 37, without an intermediate pipe shutoff device 36.

Instead of removing the water 58 from the reservoir 66 with the aid of a suction lance, it can be provided in particular that the fluid line 12h is connected directly to the reservoir 66 via a connection 67.

In an alternative exemplary embodiment according to FIG. 7, only a single, common water reservoir 66 is provided both for supplying the metering pump 15 with flushing medium and for supplying the flush pump 16 with flushing medium, which manages with a single pipe shutoff device 35.

In the exemplary embodiment of FIG. 1, three switching devices 14a, 14b, 14c are provided, which will be explained with reference to the exemplary embodiment of FIGS. 2 to 4. FIG. 2 schematically shows the functional principle of a switching device 14a.

According to FIG. 2, the switching device 14a comprises a housing 47, which is designed to accommodate a displaceable valve body 48 in the form of a ball.

According to FIGS. 2 and 3, the valve housing comprises two inlets 46a, 46b and an outlet 45.

The first inlet 46a is connected to the fluid line portion 12k and 12h and is used for the supply of flushing medium. It is in communicative connection with the flush pump 16.

The second inlet 46b is connected to the fluid line 12e and is in communicative connection with the mixing distributor device 25.

The outlet 45 is connected to the fluid line 12l and enables a communicative connection with the target apparatus 13a.

The valve body is in particular a ball 48, which is rotatable about an axis of rotation 49. In the exemplary embodiment of FIGS. 2 to 4, the valve body 48 has a passage channel 51 that is bent approximately at right angles. In a first switching position 18 of the switching device 14a, as shown in FIG. 2, connects the inlet 46b with the outlet 45. At the same time, a sealing surface 50b on the outer circumferential surface of the valve body 48a ensures that the inlet 46b is sealed with respect to the outlet 45 and with respect to the other inlet 46a.

In this first switching position 18, a delivery of medium, e.g. of the medium 11a, can be effected by the switching device 14a to the point 22a, or to another point which is located further downstream of the first switching device 14a.

As soon as the media delivery has been completed, in particular after a flushing of the medium 11a through the mixing distributor 25 has been detected, the control device 17 of the metering device 10 can directly or indirectly address a motorized drive 52a and the switching device 14a is moved to a second switching position 19 or to a second switch state 19 according to FIG. 3. In the course of the addressing the motorized drive 52a, the valve body 48 can be rotated by approximately 90 degrees clockwise, starting from a position as shown in FIG. 2, and adopt a position according to FIG. 3.

In FIG. 3, the switching device 14a is in its second switching position 19.

Here, the outlet 45 is now connected to the inlet 46a. In contrast, the sealing surface 50a completely seals the inlet 46b.

In this second switching position 19 of the valve body 48, flushing medium, i.e. water, can be delivered through the first switching device 14a by the flush pump 16. This delivery takes place under high pressure, the switching device 14a in particular ensuring pressure tightness with respect to the inlet 46b and thus with respect to the mixing distributor device 25 connected to the fluid line portion 12e.

The switching device 14a according to FIGS. 2 to 4 is designed as a so-called ball valve assembly 38.

In the present patent application, a ball valve is denoted by reference character 38.

FIG. 4 shows a typical design of a ball valve 38:

Here it can be seen that an electromotoric drive 52a, is, via a shaft 53, which provides, for example, the output shaft of the electric motor 52a, or is connected thereto, is directly fixedly connected to the valve body 48 and can perform the corresponding displacement of the valve body 48.

Between the drive 52a and the shaft 53, for example, there may be a gear mechanism, e.g. a planetary gear mechanism, which is not shown, in order to generate the large torques required to displace the valve body 48.

The exemplary embodiment of FIG. 5 shows the switching device 14a of FIG. 2 in a third switch state 61.

In numerous exemplary embodiments of the invention, it may be provided that a switching device 14, 14a, 14b, 14c can adopt such a third switching position 61 in which all inlets 46a, 46b are sealed relative to one another and in particular also relative to the outlet 45. For this purpose, the ball 48, or another suitably-dimensioned valve body 48 can be equipped with suitable sealing surfaces 50c, 50d, 50e.

In particular, if the metering device 10 does not have a second part 27 of a mixing distributor device 25, as is explained in greater detail below, in particular with reference to the exemplary embodiment of FIG. 19, it is beneficial if each of the switching devices 14a, 14b, 14c can adopt a third switching position 61 in which all the inlets 46a, 46b and also the outlet 45 are sealed against each other in a fluid-tight, in particular pressure-resistant, manner.

As a rule, the metering device 10 of the exemplary embodiment in FIG. 1 functions as follows:

After having received a media request command from the target apparatus 13a, the control device 17 of the metering device 10 addresses the motorized drives 65a, 65b and 52a and ensures that the communication paths from the container 20a to the target apparatus 13a are switched.

The metering pump 15 then delivers the predetermined amount of medium 11a to the point 22a. The control device 17 can then address the drive 65a and then the metering pump 15 again in order to deliver flushing medium 58 through the mixing distributor 25 to the point 22a and to flush the fluid line paths 12d to 12e.

Subsequently, the control device 17 addresses the drive 52a and then switches the switching device 14a to its second switch state 19. Then, the control device 17 can address the flush pump 16 and cause the target flushing, and thus a delivery of the medium 11a, which is already located at the point 22a, along the long line paths 12l to the target apparatus 13a.

If, at this point in time, the control device 17, receives a request for a certain amount of another medium, e.g. medium 11b, from another target apparatus, e.g. from the target apparatus 13b, the control device 17 can address the motorized drives 65a, 65b and 52b and switch a communication path, e.g. from the container 20b to the target apparatus 13b. This involves the switching device 14b adopting its first switch state 18. In this first switching position 18 of the second switching device 14b, the communication path between the container 20b and the target apparatus 13b is completely sealed with respect to the flush pump 16.

Subsequently, by addressing the metering pump 15, the metering device 10 can cause the medium 11b to be delivered to the point 22b, downstream of the switching device 14b.

While the metering pump 15 conveys the medium 11b towards the direction of the target apparatus 13b to the point 22b, the flush pump 16 can simultaneously perform a target flushing of the medium 11a towards the target apparatus 13a. Thus, the supply of multiple target apparatuses 13a, 13b, 13c with different media 11a, 11b can be performed extremely efficiently and quickly, and without waiting times. At the same time, the two pumps 15, 16 can be designed to be optimized so that a precise metering with long service life of the metering device 10 is achieved.

In the exemplary embodiment shown in FIG. 1, the multiple switching devices 14a, 14b, 14c are arranged in a block arrangement 55 and/or are arranged compact. The multiple switching devices 14a, 14b, 14c of the exemplary embodiment of FIG. 1 can in particular be combined in terms of design, which simplifies the design and construction.

In the exemplary embodiment of FIG. 6, the three switching devices 14a, 14b, 14c are arranged separately and can, for example, be arranged at a distance from one another. It may also provided here that each of the three switching devices 14a, 14b, 14c can be addressed via its own signal line 44f, 44g, 44h. As shown in FIG. 6, the three switching devices 14a, 14b, 14c can be addressed via a sub-control device 43c, or directly by the control device 17 of the metering device 10.

The individual switching devices 14a, 14b, 14c are denoted in FIG. 6 with the reference character 54a, 54b, 54c. They can be arranged at a distance from each other.

In the exemplary embodiment of FIG. 7, the two pipe shutoff devices 35, 36 of the exemplary embodiment of FIG. 1 are combined to form a common pipe shutoff device 56. It is a common water reservoir 66 provided. The water reservoir 66 of FIG. 7 is used to supply the mixing distributor device 25 via a suction lance 39c and also to supply the flush pump 16 via the line connection 67. Otherwise, the design has not changed here.

The particular feature of the exemplary embodiment of FIG. 7 can also be provided in any other exemplary embodiment.

The exemplary embodiment in FIG. 8a essentially corresponds to the exemplary embodiment in FIG. 7 with the following particular feature:

The water reservoir 66 is connected to the intermediate line portion 34 via a dilution line 70, the so-called dilution bypass 70. The dilution line 70 has a port 72 to the intermediate line 34, which is arranged downstream of the metering pump 15.

A dilution pump 68 is associated with the dilution bypass 70. The dilution pump 68 is used to pump flushing medium, namely water, through the dilution bypass 70 through the fluid line paths downstream of the metering pump 15, and to preferably carry out this delivery while the metering pump 15 is delivering the corresponding medium 11a, 11b, or shortly thereafter.

According to the invention, this proves advantageous, if the media 11a, 11b include certain chemicals that require dilution with water for the purpose of delivering, as they may otherwise be subject to gel formation, for example, or may be prone to form plugs or lumps.

The dilution pump 68 is thus used for the additional supply of water in order to achieve delivery of the medium 11a, 11b—when using certain media—to the point 22a, 22b.

In the exemplary embodiments of the invention, the metering pump 15 and the dilution pump 68 can in particular be operated in parallel, i.e. simultaneously.

The dilution pump 68 is connected to the control device 17 via a signal and control line 44x and can be addressed by the latter.

The dilution bypass 70 can be opened or closed in particular via a valve 69. The valve 69 can be connected to the control device 17 via a control line 44y and addressed by the latter.

The control device 17 of the metering device 10 can, upon receipt of request commands for such media that require additional dilution, address the valve 69 via the line 44y as required and open it when this medium is metered and at the same time address the dilution pump 68, so that the corresponding medium already diluted reaches the point 22a, downstream of the corresponding switching device 14a.

In a further exemplary embodiment of the invention, a switchable valve 69 or a valve 69 that can be addressed by the control device 17 is not required or not provided.

One such exemplary embodiment of the invention is shown in FIG. 8c. Here, instead of an electrically switchable valve, a non-return valve 69b, i.e. in particular a passive valve, is provided. In particular, this prevents medium from entering the dilution bypass 70 undesirably when media is conveyed by the metering pump 15b.

The non-return valve 69b is configured to be passive and allows water to be delivered through the dilution bypass 70 when the dilution pump 68 is in operation, but prevents unintentional delivery of medium through the metering pump 15b into the dilution bypass 70 when the dilution pump 68 is switched off-and possibly also when it is switched on.

The non-return valve 69b can, for example, comprise a switching ball that can be accommodated in a valve seat.

When fluid flows in the direction of delivery of the dilution pump 68, i.e. upwards with reference to FIG. 8c, the switching ball is lifted from its valve seat. If the fluid flows in the opposite direction, it reaches the valve seat and blocks the fluid flow.

FIG. 8b shows another exemplary embodiment. Neither an electrically switchable valve 69 nor a passive non-return valve 69b is provided here. Instead, the dilution pump 68 is pressure-tight in this exemplary embodiment. Here, too, the medium pumped by the metering pump 15b is prevented from entering the dilution bypass 70.

The advantage of the exemplary embodiments of FIGS. 8a, 8b, 8c, which each have a separate dilution pump 68, lies in particular in the fact that the dilution rate can be adjusted, in particular by adjusting the capacity of the dilution pump 68. In these exemplary embodiments of FIGS. 8a, 8b, 8c, the dilution pump 68 thus has an adjustable capacity. The capacity can be adjusted to achieve a desired dilution ratio.

The special features of the exemplary embodiment of FIG. 8a can also be provided in any other exemplary embodiment of the invention.

FIG. 9 shows another exemplary embodiment:

Here, a dilution bypass 70b branches off from the fluid line portion 12h downstream of the flush pump 16, which also continues the line portion 34 via a port 72 downstream of the metering pump 15b.

In this exemplary embodiment, the metering pump 15b can be designed to be pressure-resistant.

Again, a valve 69b is provided that can be addressed by the sub-control 43a or by the control device 17 via a control line 44y.

Here too, in the event that a medium 11a, 11b requires dilution, water 58 can be added at the earliest possible point in time.

An additional third pump, in particular the dilution pump 68 of the exemplary embodiments shown in FIGS. 8a to 8c, can be dispensed with.

Here, the flush pump 16 can be used to ensure the desired supply of water during media metering.

In the event that the metering device 10 receives a request command from a target apparatus 13 for a medium 11a, 11b that requires a dilution, during or after metering, the control device 17 can address the valve 69b, open the connecting line 70b, address and drive the flush pump 16 if necessary, or use the already driven flush pump 16 to feed water into the intermediate line portion 34 in order to dilute the medium 11a, 11b and convey it with a larger amount of water to the point 22a, 22b, 22c downstream of the switching device 14a, 14b, 14c.

FIG. 10 shows another exemplary embodiment:

Here, the switching devices 14d, 14e, 14f are not designed as a three-way valve, as in the exemplary embodiment of FIG. 7, but as a four-way valve.

This will be explained later using FIG. 11.

In the exemplary embodiment of FIG. 10, during the metering of medium 11a, 11b by the metering pump 15b, in a corresponding switching position of the switching device 14d, 14e according to FIG. 11, a dilution with water can be caused at the same time as the media delivery with the aid of the flush pump 16.

FIG. 11 explains that the four-way valve, for example again a ball valve assembly 38, has a passage channel 71. Said channel can be T-shaped or Y-shaped, for example, and connect two inlets 46c, 46b and an outlet 45 at the same time in the switching position shown in FIG. 11.

As FIG. 10 shows, dilution bypasses 70c, 70d, 70e each branch off from the fluid line portion 12h immediately upstream of the three switching devices 14d, 14e, 14f, which, as shown in FIGS. 11 and 12 are supplied to a third input 46c of the respective switching device 14d, 14e, 14f.

The switching device 14d can adopt a switching position as shown in FIG. 11, in which the section 12e, along which the medium is delivered, is directly communicatively connected to the fluid section 12l downstream of the switching device 14d, and at the same time the dilution bypass 70d is also communicatively connected to the fluid section 12l due to the T-shaped design of the passage channel 71.

As FIG. 12 shows, in a changed switching position 19 as shown in FIG. 12, the switching device 14d can block the inlet 46b and the inlet 46c via the sealing surfaces 50a, 50b and only communicably connect the inlet 46c to the outlet 45.

FIG. 13 shows a switch state in which all inputs 46a, 46b, 46c and the outlet 45 are sealed from each other.

The switching device 14d of the exemplary embodiment of FIGS. 10 to 12 ensures in any case-regardless of how the switching device is actually designed that a communicative connection is established between the metering pump 15b and the target apparatus 13a in a first switching position, that a communicative connection is established between the metering pump 15b and the target apparatus 13a in a second switching position and that a communicative connection is established between the metering pump 15b and the target apparatus 13a in a second switching position and in a further switching position, a communicative connection is established between the metering pump 15b, the flush pump 16 and the target apparatus 13a in order to dilute the media 11a, 11b which require dilution.

The switch state, in which the switching device 14d establishes a communicative connection between the metering pump 15b, the flush pump 16 and the corresponding target apparatus 13a, such as the switch state shown, for example, in FIG. 11, is also referred to as the fourth switch state 73.

In an advantageous embodiment of the invention, the metering pump 15b is advantageously designed to be pressure-tight, and withstands the pressure generated by the flush pump 16 in the dilution line 70, 70b, 70c, 70d, 70e.

The exemplary embodiments of FIGS. 9 to 13 each disclose a dilution bypass 70b, 70c, 70d, 70e, which is supplied with flushing medium directly from the flush pump 16 in the manner of a dilution supply line.

The invention also includes that when a device for flow limitation is assigned to a dilution bypass. In fluidic terms, throttles can therefore be provided. A throttle can be, for example, a pressure reducer and/or a flow reducer.

Optionally, a device 74 for limiting the flow, i.e. a throttle, is indicated in the dilution supply line 70b in FIG. 9. Such a throttle can, for example, also be arranged upstream of each of the three switching devices 14d, 14e, 14f, of the exemplary embodiment of FIG. 10, in the area of the dilution bypasses 70c, 70d, 70e.

The invention also relates to a case in which a measuring device 75 is arranged downstream of the flush pump 16—as optionally shown in the exemplary embodiment of FIG. 7—which device is designed as a flowmeter or flow measuring device. The measuring device 75 can for example determine, whether flushing medium has actually been delivered after the flush pump 16 has been addressed and/or whether an error has occurred. The measuring device can be connected to the control device 17 of the metering device 10 via a signal and connecting line 44z.

In the event that the expected measurement signal is not produced at the measuring device 75 as a result of an addressing of the flush pump 16, the metering device 10 can generate an alarm and, for example, visually or acoustically or automatically indicate to an operator that the scavenging medium has not been delivered properly.

This can occur, for example, if the flushing has not worked or also if a pipe is blocked.

Of course, a throttle 74 and/or a measuring device 75 can be provided for each of the exemplary embodiments.

With reference to the exemplary embodiments of FIGS. 14 to 18, another exemplary embodiment of a switching device 14d is explained, which is designed as a four-way valve or multi-way valve, in particular in the manner of a ball valve, and provides similar functionalities to the exemplary embodiment of FIGS. 11 to 13, but has a different design:

FIG. 14 schematically shows only the valve body 48 in the form of a ball pivotable about its pivot axis 49. Three mutually perpendicular channel sections 76a, 76b are incorporated in the spherical valve body 48, of which only two channel sections, namely the channel sections 76a, 76b, are shown in FIGS. 14 to 18. The third channel section, (not shown) extends from the confluence area or center area, in which the two channel sections 76a, 76b meet, perpendicular to the paper plane in the viewing direction of the viewer up to the output (not shown).

The valve body, which is formed by a ball, is arranged in a ball housing, not illustrated in FIGS. 14 to 18, similar to the ball housing of FIGS. 11 to 13. The motorized drive is not shown in FIGS. 14 to 18.

In the switching position shown in FIG. 14, the valve body 48 connects the inlet 46b, i.e. at the same time the fluid line portion 12b, with the outlet (not shown). Here, only medium that is delivered by the metering pump is allowed to pass through the switching device 14d.

The remaining inlets 46a, 46c are sealed.

In the valve position shown in FIG. 15, which, based on FIG. 14, a valve rotation about the pivot axis 49 by approximately 90° counterclockwise, the two inlets 46b, 46c are connected to the outlet, not shown. Here, medium and dilution medium, in particular with a reduced flow rate, are conveyed to the outlet.

The inlet 46a for the flushing agent, which leads directly to the flush pump 16 is blocked here.

FIG. 16 shows a switching device 14d in a further switch state, which requires a further counterclockwise rotation of the valve body 48 by 90°, starting from the position according to FIG. 15.

Here, inlet 46a and inlet 46c are connected through to the output not shown. Flushing medium is thus provided directly from the fluid line portion 12k by the flush pump 16, and flushing medium is also supplied via the dilution bypass 70d.

The media inlet 46b is sealed.

Based on FIG. 16, the valve body can be pivoted by a further 90° around the pivot axis 49 anti-clockwise so that the switching position as shown in FIG. 17 is reached.

Here, only input 46a is connected through to the output not shown. In this switching position is a communicative connection between the target apparatus 13 and the flush pump 16 are provided.

FIG. 18 shows a further, fifth switch state, which, starting from the valve position shown in FIG. 17, requires a further rotation of the valve body 48 by approximately 45° counterclockwise about the pivot axis 49:

Here, all three inputs 46a, 46b and 46c are sealed from each other.

Another exemplary embodiment of a metering device 10 according to the invention is shown in FIG. 19.

This exemplary embodiment corresponds essentially to the exemplary embodiment of FIG. 1.

Here, in contrast to the exemplary embodiment of FIG. 1, the second part 27 of the mixing distributor device 25 of the exemplary embodiment of FIG. 1 has been omitted. Instead, the delivery line 79 between the metering pump 15 and the switching devices 14a, 14b, 14c has been modified. In the area of the switching device 14a, 14b, 14c, the delivery line 79 is of a flute-like design and comprises only short delivery line portions 80a, 80b, 80c, in the manner of branches, which branch off from the distributor-like line 79.

FIG. 19 shows a switch state of the first switching device 14a, in which the metering pump 15 is connected to the target apparatus 13a. According to FIG. 19, the two other switching devices 14b, 14c are each in their third switch state 61, in which all ports of the corresponding switching device 14b, 14c are shut off fluid-tight and pressure-resistant against each other.

After a delivery of medium from the metering pump 15 through the first switching device 14a has been initiated, the control device 17, 43c can address the switching device 14a and transfer it to a changed switch state, not shown in FIG. 19, in which the flush pump 16 is connected to the target apparatus 13a.

Subsequently, a target flushing can be performed from the flush pump 16 to the target apparatus 13a through the first switching device 14a, wherein the fluid-tight communication paths blocked by the two switching devices 14b and 14c ensure that no line pressure acts on the metering pump 15 or on one of the target apparatuses 13b and 13c that cannot be reached by a target flushing.

The exemplary embodiment of FIG. 20 corresponds to the exemplary embodiment of FIG. 1 with the following difference: According to FIG. 20, a flushing device 90 is provided instead of a flush pump 16, which does not require its own pump drive. Instead, the line pressure in the domestic water network 89 is used to deliver the flushing medium and to pump the flushing medium to the target apparatus.

The sub-control device 43c can, for example, address a valve 78 via a signal line 44x, in particular open or close it. Such a valve 78 can also be designed to be manually openable or closable.

In particular, in the exemplary embodiment of FIG. 20, the flushing device 90 comprises a pipe shutoff device 77, which can be used without a free-fall section, and which in particular is capable of transferring the line pressure prevailing in the domestic water network 89 to the downstream-connected sections 12h of the fluid line paths. For example, the pipe shutoff device 77 may also include a non-return valve that ensures chemical and bacteriological pipe separation. Such a non-return valve may comprise, for example, a valve ball 88, which is merely indicated in FIG. 20, and a valve seat 87.

By opening the valve 78 caused by the sub-control device 43c, flushing medium can be pumped and delivered directly from the domestic water network 89 through the delivery line 12h. With the aid of the line pressure of the domestic water network 89, the flushing medium can delivered to the respective target apparatus 13a, 13b, 13c via the respective switching device 14a, 14b, 14c, provided that this adopts a corresponding switch state.

FIG. 21 shows another exemplary embodiment of a metering device 10 according to the invention, which also does not require a flush pump, but instead has a flushing device 90. Again, the input side of the switching devices 14a, 14b, 14c is connected directly to the domestic water network 89 without the interposing of a separate flush pump 16. Here too, the line pressure in the domestic water network 89 is used to deliver the medium to the target apparatuses.

Again, a pipe shutoff device 77 may provided, which switches the line pressure through.

Compared to the exemplary embodiment of FIG. 20, the difference is that the valve 78 that can be addressed by the sub-control device 43c is omitted. Here the line water pressure of the domestic water network 89 is present directly at the inputs of the switching devices 14a, 14b, 14c.

The exemplary embodiment in FIG. 22 illustrates that a dilution pump 68 provided in the exemplary embodiment in FIG. 8a can be replaced by a dilution device 91.

The dilution device 91 comprises a fluid line 92, which is also directly connected to the domestic water network 89. The dilution device 91 uses the line pressure in the domestic water network 89 to deliver flushing medium for the purpose of dilution and supplies flushing medium to a line portion directly downstream of the metering pump 15.

A separate dilution pump 68, which is provided in the exemplary embodiment of FIG. 8a, can be dispensed with in this exemplary embodiment.

Moreover, it should be noted that: In all exemplary embodiments of the invention, the second part 27 of the mixing distributor device 25 can be omitted, as described with reference to the exemplary embodiment of FIG. 19.

In all exemplary embodiments of the invention, a flush pump 16 may be replaced by a flushing device 90, as shown, for example, in FIGS. 20 to 23.

In all exemplary embodiments of the invention, a dilution pump 68 can be replaced by a dilution device 91 which is directly connected to the domestic water network 89 and which uses the line pressure prevailing in the domestic water network 89 to deliver the flushing medium for the purpose of diluting media requiring dilution, as shown in the exemplary embodiment in FIG. 22.

1-26. (canceled)

27. A metering device for metering and supplying media via fluid lines to at least one target apparatus, wherein the metering device comprises a switching device which is connected, on an input side, to a metering pump and to a flush pump, or to a flushing device, and which is connected, on an output side, to a target apparatus, and which can be addressed by a control device of the metering device to change its switch state, wherein the switching device provides a communicative connection between the metering pump and the target apparatus in a first switch state, and provides a communicative connection between the flush pump or the flushing device and the target apparatus in a second switch state.

28. The metering device according to claim 27, wherein the target apparatus is a commercial textile washing machine.

29. The metering device according to claim 27, wherein, for performing a metering process with the aid of the metering pump, the metering device is configured to take out of a specific volume of medium from a container and convey the volume along a first fluid line portion in a direction towards the target apparatus as far as to a point downstream of the switching device.

30. The metering device according to claim 29, wherein the metering pump is addressable by the control device for performing the metering process.

31. The metering device according to claim 29, wherein a conveyance of the volume along a second fluid line portion from the point downstream of the switching device to the target apparatus is causable by the metering device, for performing the metering process with aid of the flush pump or the flushing device.

32. The metering device according to claim 31, wherein the flush pump or the flushing device is addressable by the control device for performing the metering process.

33. The metering device according to claim 27, wherein a length of the second fluid line portion is more than 5 m, in particular more than 10 m, and/or the second fluid line portion bridges a large height difference, in particular more than 2 m.

34. The metering device according to claim 27, wherein the metering device is connected on an input side to at least one container which is filled with a medium.

35. The metering device according to claim 27, wherein the metering device is connected on an input side to a plurality of containers.

36. The metering device according to claim 35, wherein the plurality of containers are filled with different media and/or with flushing medium.

37. The metering device according to claim 27, wherein the metering pump and the flush pump are configured differently, and in particular comprise different pump types and/or different performance classes.

38. The metering device according to claim 37, wherein the metering pump is configured to deliver small volumes and/or for delivering along fluid line portions which are kept short and/or for delivering along only small height differences.

39. The metering device according to claim 37, wherein the flush pump is configured to deliver large volumes, along fluid line portions designed to be long and/or along large height differences.

40. The metering device according to claim 27, wherein the metering pump is a peristaltic pump.

41. The metering device according to claim 27, wherein the flush pump is a diaphragm pump or a centrifugal pump or the flushing device for delivering flushing medium to the target apparatus uses a line pressure prevailing in a line network of a mains water connection.

42. The metering device according to claim 27, wherein the metering device comprises a plurality of switching devices.

43. The metering device according to claim 42, wherein the metering device comprises a mixing distributor device that communicatively connects the metering pump to a selected one of the plurality of switching devices.

44. The metering device according to claim 27, wherein the metering device is connected to a plurality of target apparatuses.

45. The metering device according to claim 27, wherein the metering device is connected on an input side to a domestic water connection via at least one pipe shutoff device.

46. The metering device according to claim 27, wherein the switching device is a ball valve which is driven by a motor.

47. The metering device according to claim 27, wherein the switching device is a three-way valve or a four-way valve.

48. The metering device according to claim 27, wherein the switching device, in the second switch state, blocks the communicative connection between the metering pump and the target apparatus, and/or switching device is able to adopt a third switch state, in which all of inlets inlets are blocked against each other and against the outlet.

49. The metering device according to claim 48, wherein the switching device, in the second switch state, blocks the communicative connection between the metering pump and the target apparatus it in a pressure-resistant manner, and/or the switching device is able to adopt a third switch state, in which all of the inlets are blocked against each other and against the outlet in a pressure-resistant manner.

50. A method for metering and supplying media via fluid lines to at least one target apparatus, wherein the metering device is connected to at least one container which is filled with a medium, wherein the metering device has a control device with which, in order to perform a metering process, a metering pump and a flush pump or a flushing device can be addressed and a switching device which, in a first switch state, provides a communicative connection between the metering pump and the target apparatus and which, in a second switch state, provides a communicative connection between the flush pump or the flushing device and the target apparatus, comprising the steps of:
a) addressing the switching device by the control device to switch the switching device to the first switch state;
b) addressing the metering pump by the control device to take out a predetermined amount of medium from the container and deliver it to a point downstream of the switching device;
c) addressing the switching device by the control device to switch the switching device to the second switch state; and
d) addressing the flush pump or the flushing device by the control device to deliver the predetermined amount of medium from the point downstream of the switching device to the target apparatus.

51. The method according to claim 50, wherein the target apparatus is a commercial textile washing machine.

52. A method for metering and supplying media via fluid lines to a plurality of target apparatuses, wherein the metering device is connected to a plurality of containers which are filled with different media, wherein the metering device has a control device, by which a metering pump and a flush pump or a flushing device as well as multiple switching devices can be addressed for performing a metering process, wherein a switching device is assigned in each case to a target apparatus, wherein a switching device establishes a communicative connection in each case in a first switch state between the metering pump and the target apparatus assigned to this switching device and, in a second switch state, provides a communicative connection between the flush pump or the flushing device and the target apparatus assigned to this switching device, the method comprising the steps of:
e) addressing a first switching device by the control device to switch the first switching device to the first switch state;
f) addressing the metering pump by the control device to remove a predetermined amount of medium from the container and deliver it to a point downstream of the first switching device;
g) addressing the first switching device by the control device in order to switch the first switching device to the second switch state;
h) addressing the flush pump or the flushing device by the control device to deliver the predetermined amount of medium from the point downstream of the first switching device to the target apparatus;
i) addressing a second switching device by the control device to switch the second switching device to the first switch state;
j) addressing the metering pump by the control device to remove a predetermined amount of medium from the container and deliver it to a point downstream of the second switching device; and
k) performing step j) before step h) is finished.

53. The method according to claim 52, wherein the plurality of target apparatuses is a plurality of commercial textile washing machines.

54. A metering device for metering and supplying media via fluid lines to at least one target apparatus, wherein the metering device comprises a switching device which is connected on an input side to a metering pump, a dilution pump and to a flush pump or a flushing device, and which is connected on an output side to a target apparatus, and which can be addressed by a control device of the metering device to change a switch state of the switching device, wherein the switching device provides a communicative connection between the metering pump, the dilution pump and the target apparatus in a first switch state and provides a communicative connection between the flush pump or the flushing device and the target apparatus in a second switch state.

55. The metering device according to claim 54, wherein the target apparatus is a commercial textile washing machine.

56. A metering device for metering and supplying media via fluid lines to at least one target apparatus, wherein the metering device comprises a switching device which is connected on an input side to a metering pump and to a flush pump or a flushing device and which is connected on an output side to a target apparatus, wherein the switching device can be addressed by a control device of the metering device to change a switch state of the switching device, wherein the switching device in a first switch state provides a communicative connection between the metering pump and/or a dilution bypass which can be acted upon by the flush pump or the flushing device and the target apparatus, and in a second switch state provides a communicative connection between the flush pump or the flushing device and the target apparatus.

57. The metering device according to claim 56, wherein the target apparatus is a commercial textile washing machine.

58. A metering device for metering and supplying media via fluid lines to at least one target apparatus, wherein the metering device has a switching device which is connected on an input side to a metering pump, a dilution bypass, a flush pump or a flushing device and which is connected on an output side to a target apparatus, wherein the switching device can be addressed by a control device of the metering device to change a switch state of the switching device, wherein the switching device in a first switch state provides a communicative connection between the metering pump, the dilution bypass, which can be acted upon by the flush pump or the flushing device, and the target apparatus, and in a second switch state provides a communicative connection between the flush pump or the flushing device and the target apparatus.

59. The metering device according to claim 58, wherein the target apparatus is a commercial textile washing machine.
